(19) United States
(12) Patent Application Publication
(10) Pub. No.: US 2017/0347036 A1
(43) Pub. Date: Nov. 30, 2017

(54) Driver Assistance System

(71) Applicant: Conti Temic microelectronic GmbH, Numberg (DE)

(72) Inventors: Dieter Krökel, Eriskirch (DE); Konrad Rothenhäusler, Achberg (DE); Ulrich Roskoni, Wöllstadt (DE); Tobias Schmalriede, Frankfurt (DE)

(73) Assignee: Conti Temic microelectronic GmbH, Nürnberg (DE)

(21) Appl. No.: 15/674,082

(22) Filed: Aug. 10, 2017

Related U.S. Application Data
(63) Continuation of application No. PCT/DE2016/200073, filed on Feb. 4, 2016.

(30) Foreign Application Priority Data
Feb. 10, 2015 (DE) 10 2015 202 330.3

(51) Int. Cl. H04N 5/232; H04N 5/345; H04N 5/225; B60R 1/00; G06K 9/00; H04N 5/347; H04N 5/33

(52) U.S. Cl. CPC H04N 5/23293; H04N 5/347; H04N 5/345; H04N 5/332; H04N 5/23296; H04N 5/23232; B60R 1/00; G06K 9/00805; H04N 5/2251; B60R 2300/602; B60R 2300/306; B60R 2300/105; B60R 2300/802

(57) ABSTRACT

The disclosure relates to a driver assistance system for a motor vehicle, such as a truck. The driver assistance system includes an environment camera with an image sensor and an optical system. The driver assistance system also includes an imaging unit and a display element in the interior of the motor vehicle. The environment camera, the imaging unit, and the display element form a digital exterior mirror, where the digital exterior mirror is arranged such that at least two visual field regions, namely a first visual field region and a second visual field region, are mapped with different magnifications.

### CROSS-REFERENCE TO RELATED APPLICATIONS

This application claims the benefit of PCT Application PCT/DE2016/200073, filed Feb. 4, 2016 which claims priority to German Application DE 10 2015 202 330.3, filed Feb. 10, 2015. The disclosures of the above applications are incorporated herein by reference.

### TECHNICAL FIELD

The disclosure relates to a driver assistance system for a motor vehicle, particularly for a truck. The driver assistance system includes an environment camera with an image sensor and with an optical system, including an imaging unit and including a display element in the interior of the motor vehicle, which together form a digital exterior mirror.

### BACKGROUND

Major efforts are currently being made to reduce the fuel consumption of motor vehicles. One way to do this is to design corresponding motor vehicles in such a way that they have the lowest possible drag coefficient and the lowest possible air flow area. To this end, it is known to replace the conventional exterior mirror or side mirror by an electronic or digital exterior mirror or side mirror, which is substantially formed by a camera and a display element, usually an LCD display, where the display element is arranged in the passenger compartment of the motor vehicle and wherein the environment camera substantially detects the area in the environment of the motor vehicle, which is otherwise visible for the vehicle driver via the conventional exterior mirror or side mirror.

### SUMMARY

Therefore, it is desirable to have a driver assistance system, to replace the conventional exterior mirror. The driver assistance system is designed for a motor vehicle and particularly for a truck. The driver assistance system includes an environment camera with an image sensor and with an optical system, an imaging unit and a display element in the interior of the motor vehicle, which together form a digital exterior mirror or side mirror. The digital exterior mirror is arranged here such that at least two visual field regions, namely a first visual field region and a second visual field region, are mapped with different magnifications.

In this way, it is, inter alia, possible to ensure that the image information reproduced by the display element substantially reproduces that which a vehicle driver would see with a conventional exterior mirror. It should be noted here that conventional exterior mirror or side mirror often has two regions in automobiles. One region reproduces the environment of the motor vehicle as an inset, thus allowing a greater visual field to be covered by the mirror. In this way, what is known as the dead angle is kept as small as possible. This way of mapping the environment can in principle be imitated digitally or electronically, in that two visual field regions with different magnifications are mapped.

This configuration of an electronic exterior mirror may be used in trucks or buses, where the conventional exterior mirror or side mirror frequently includes a plurality of individual mirrors, mirror segments or mirror elements, where the individual mirror segments or individual mirrors are provided for monitoring different regions in the environment of a corresponding truck or bus and the environment is reproduced with varying warping or distortion. The individual mirror elements or mirror segments thus perform practically different functions, which are similarly implemented by an electronic mirror presented here and particularly by the driver assistance system presented here.

Here it is, inter alia, advantageous, to also arrange a plurality of display elements, display regions or even a plurality of displays in the passenger compartment, so that virtually every mirror element or every individual mirror of the conventional exterior mirror is replaced by its own display, its own display element or at least its own display region. In some examples, these are also arranged similarly to the elements of the conventional exterior mirror, so that a vehicle driver or operator does not have to adjust their position or adapt, but is able to cope with the system almost intuitively.

In some implementations, the digital exterior mirror is furthermore arranged such that at least two visual field regions are mapped with different angular resolutions. In this way, for example, a greater angular range can be mapped on a given imaging surface and/or particularly relevant angular ranges can be monitored with greater resolution.

It is also expedient to use an environment camera, the image sensor of which is configured to detect electromagnetic radiation in the wavelength range between approximately 300 nm and approximately 2,000 nm. Corresponding environment cameras are already used in the automotive area, for example to monitor the traffic in advance of the motor vehicle, and accordingly an environment camera does not have to be specifically designed and developed for the driver assistance system presented here.

Depending on the intended application, in some examples, the environment camera is equipped with a wavelength band-pass filter to create an environment camera which substantially responds to what is referred to as visible light in the range of approximately 400 nm to approximately 750 nm.

Alternatively, the environment camera may be configured such that it responds not only to light in what is referred to as the visible range, but furthermore also to what is referred to as infrared light, for example in the range around 900 nm, so that the environment camera is able to operate at night or in corresponding ambient light conditions additionally or alternatively according to the principle of an infrared night-vision device, so that it is able to pick out objects in the environment of the motor vehicle even in unfavorable ambient lighting conditions.

If the environment camera is provided with corresponding infrared sensitivity, then in some examples, it is also provided that the environment camera is supplemented by an infrared light source, which emits corresponding light in the visual field region of the environment camera.

To create different magnifications and particularly different angular resolutions, it is in principle possible to design the image sensor of the environment camera such that this has two regions, in which the pixels mapping the sensor area are designed differently. For example, an image sensor is used which is made up of substantially identical pixels, and the different magnifications are then accordingly performed by the optical system. Warping, which in a corresponding optical system typically cannot be avoided, and in other applications is considered as interference, may be purposefully used here to create different magnifications in the simplest possible way.

Thus, in some implementations of the environment camera for the driver assistance system, it is provided that a simple rotation-symmetric optical system is used, but arranging this more or less offset to the image sensor, such that the optical axis of the optical system does not run as usual through the centroid of the sensor area of the image sensor, but in the direction of an image sensor edge offset to this. At the same time the optical system, compared to the prior art, has an enlarged construction, so that despite the offset arrangement the optical system substantially covers the entire sensor area of the image sensor.

In some examples, a non-rotation-symmetric optical system is used, which may be configured such that the first visual field region is mapped similarly to a wide-angle lens on a first region of the sensor surface of the image sensor, and that the second visual field region of the digital exterior mirror is mapped similarly to a telephoto lens on a second region of the sensor surface. The first region then serves primarily to cover a largest possible region in the environment of the motor vehicle, thus to achieve a good overview, which is also an advantage during maneuvering in particular. The second region, on the other hand, serves primarily to monitor the following traffic, thus to detect other highway users, who are some way behind the motor vehicle.

The second visual field region thus expediently covers an angular range of up to around 25°, where the corresponding angular range adjoins the central longitudinal axis of the motor vehicle in the substantially parallel side of the motor vehicle and is directed more or less backwards in the direction of traffic behind. The first visual field region adjoins the second visual field region, and typically covers an angular range of around 75° to 100°, though for some intended applications this angle can be more than 150°, so that the angle covered by the electronic exterior mirror can also be greater than 180°, and in some cases actually is.

In some implementations of the driver assistance system, this also has an image evaluation unit, with the help of which the image data of the environment camera are prepared and/or evaluated. Here it is provided, for example, that by the evaluation unit an object detection is implemented, with the help of which persons in the environment of the motor vehicle can be detected and then through reproduction of the image data by means of the display element, thus particularly by means of an LCD display in the passenger compartment, optically highlighted.

In this case and in others, it is also advantageous to select a favorable ratio for the various magnifications, for examples, a ratio that is an integer multiple of two. This allows simpler electronic further processing of the correspondingly generated data.

However, this may only be implemented to a limited extent with an optical system and accordingly, there is typically a gradually changing magnification across the transition area, particularly in the transition area between the two view field regions. This leads, inter alia, to undesired, distorted images, so that in such cases a kind of rectification may be performed in the imaging unit. In the process, the magnification and particularly the angular resolution in certain regions are artificially increased by interpolation and in other regions by combining of pixels, artificially decreased, so that in this way, for each visual field region, a uniform magnification or a uniform angular resolution can be achieved mathematically, with a sharp, abrupt transition between the two field view regions.

The versions and descriptions thus far relate exclusively to a replacement of an exterior mirror. Since, however, exterior mirrors or side mirrors are typically positioned on two sides of a motor vehicle, the driver assistance system is generally designed to replace these two conventional side mirrors. Accordingly, this typically includes two environment cameras, positioned on two opposing sides of the motor vehicle, and two associated display elements. The preparation and/or evaluation of the image data of the environment cameras may however be performed by means of an electronic unit.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a block diagram of a truck with a driver assistance system, including an environment camera with an optical system and an image sensor.

FIG. 2 a top view of the truck with an indication of two field view regions of the environment camera.

FIG. 3 a top view of an example of the environment camera for implementing different angular resolutions for the two visual field regions with an imaging concept for one of the two visual field regions.

FIG. 4 the top view of the example of the environment camera for implementing different angular resolutions for the two visual field regions with an imaging concept for the other of the two visual field regions.

FIG. 5 the top view of another example of the environment camera for implementing different angular resolutions for the two visual field regions with an imaging concept for one of the two visual field regions.

FIG. 6 the top view of the alternative configuration of the environment camera for implementing different angular resolutions for the two visual field regions with an imaging concept for the other of the two visual field regions.

Corresponding parts are provided with the same reference numerals in all figures.

### DETAILED DESCRIPTION

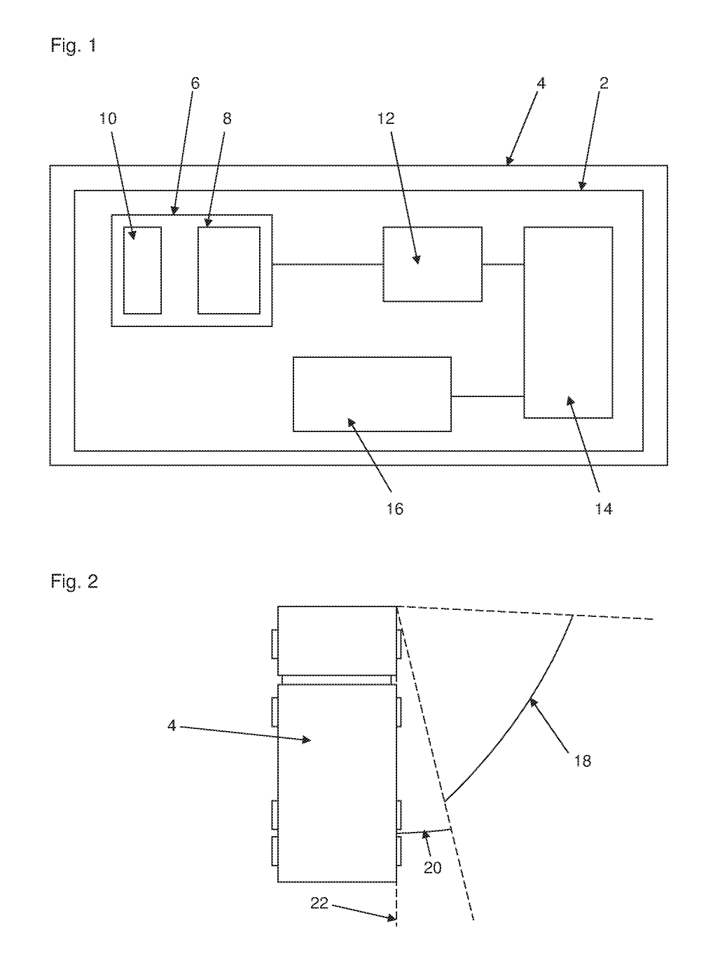

A driver assistance system 2 described by way of example in the following and sketched in FIG. 1. The driver assistance system 2 may be installed in a truck 4 and serves to support a vehicle driver or operator when driving the truck 4. The driver assistance system 2 includes an environment camera 6 having an image sensor 8 and an optical system 10. The driver assistance system 2 also includes an imaging unit 12, an image evaluation unit 14, and a display element in the form of an LCD screen 16. With the help of these modules an electronic or digital exterior mirror is implemented, to replace the conventional exterior mirror or side mirror.

In some implementations, the environment camera 6, or at least the optical system 10 of the environment camera 6, is positioned approximately in the region in which the conventional side mirror is normally arranged, and the optical system 10 of the environment camera 6 is aligned in the direction of the rear of the truck 4, so that with the help of the digital exterior mirror, as indicated in FIG. 2, a rear and side region of the environment of the truck 4 is detected by the environment camera 6 and reproduced on the LCD screen 16, arranged in the passenger compartment or driver's cab of the truck 4.

In some examples, the LCD screen 16 has an upper region and a lower region. A first visual field region 18 is reproduced during operation in the lower region having a greater surface area than the upper region. A second visual field region 20 is shown in the upper region with a smaller surface area than the lower region. As such, the LCD screen 16 essentially reproduces precisely what the driver would observe by a conventional exterior mirror, which is typically made from two individual mirrors, with similarly different surface areas, or mirror surfaces.

The image data for the two regions of the LCD screen 16 are generated with the help of just one image sensor 8 and an optical system 10, where the image sensor 8 is substantially constructed with identical pixels, which particularly have a uniform sensor surface.

The image sensor 8 is, however, at least virtually, divided into two regions, such that the image data generated by the pixels of the first area P18 are reproduced in the lower region of the LCD screen 16 and the image data generated by the second area P20 are displayed in the upper region of the LCD screen 16. For the two regions P18, P20 different magnifications, more precisely different angular resolutions, are implemented.

Therefore, the optical system 10 is designed so that the first visual field region 18 is mapped as if by a wide-angle lens on the first region of the sensor surface and the second visual field region 20 is mapped as if by a telephoto lens on the second region of the sensor surface.

Here, the second visual field region 20 extends over an angle of 25° starting from the side 22 of the truck 4, so that in this way the following traffic is particular is detected. The first visual field region 18 immediately follows the second visual field region 20 and extends over an angle of 60°, so that a total angle of 85° is detected.

As already mentioned above, for each of the two visual field regions 18, 20 a separate angular resolution is used. In some examples, the angular resolution in the second visual field region 20 corresponds to three times the angular resolution in the first visual field region 18. Since a single optical system 10 is used for the environment camera 6 and the design of the optical system 10 is subject to certain technical limits, there is no uniform value for the angular resolution for the two visual field regions 18, 20 across the respective overall visual field region 18, 20. Instead the optical system 10 has a gradually changing angular resolution in the transition area, thus in the region of the transition between the two field view regions 18, 20.

Resulting warping and distortion are eliminated during data processing in the imaging unit 12. Therefore, rectification is performed, during which the course of the angular resolution is modified by electronic post-processing of the image data, so that in the displayed images each visual field region 18, 20 over the entire respective visual field region 18, 20 has a uniform angular resolution and accordingly there is an abrupt transition between the two field view regions 18, 20. Therefore, the angle-dependent angular resolution in the second visual field region 20 is scaled up to the border with the first visual field region 18 and in the first visual field region scaled down to the border with the second visual field region 20, where for this purpose known image data rescaling algorithms are used.

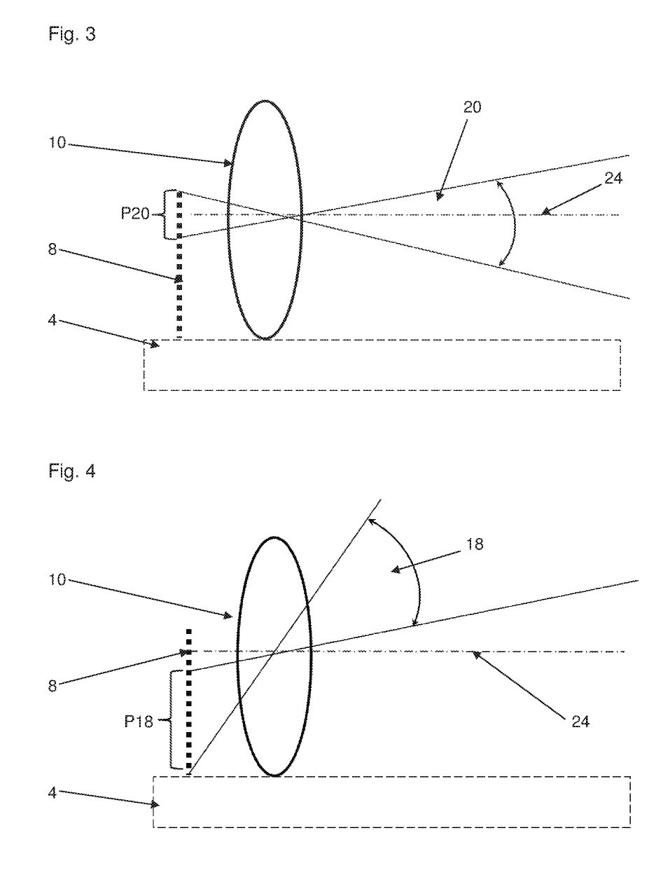

The implementation of the different angular resolutions for the two visual field regions 18, 20 takes place in FIG. 3 and FIG. 4 with the help of a rotation-symmetric optical system 10, represented in the figures by a single lens. The optical axis 24 of the rotation-symmetrical optical system 10 is, more or less, arranged offset to the image sensor 8, so that the optical axis 24 does not run through the area centroid or midpoint of the measurement surface or sensor surface of the image sensor 8, but near and offset to this at the area centroid. Moreover, the optical system 10 is over-dimensioned compared to the image sensor 8, so that despite the offset arrangement the optical system 10 fully covers the image sensor. Such a configuration allows the spherical apparition known from spherical lenses to be specifically used to implement the different angular resolution.

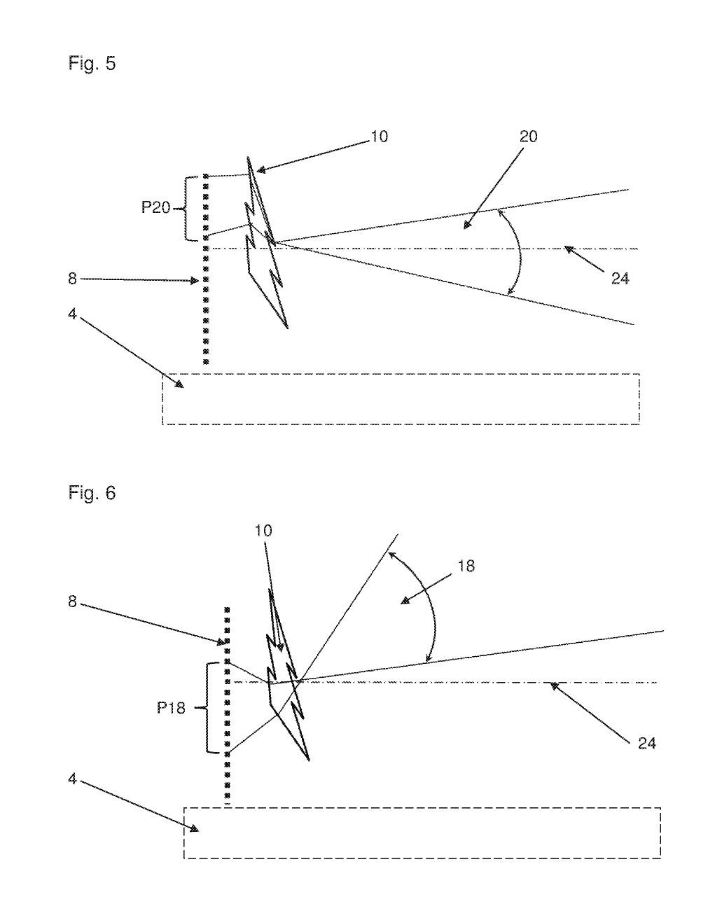

Alternatively, in some examples, a non-rotation-symmetric optical system 10 is used, which is positioned in most cases in front of the sensor surface of the image sensor 8, as shown in FIG. 5 and FIG. 6. In this case, the optical system 10 has a more complex geometry, attributable to basic prismatic forms.

The disclosure is not restricted to the examples described above. On the contrary, other variants of the disclosure can be inferred from it by a person skilled in the art, without deviating from the subject matter of the disclosure. Particularly, all individual features described in connection with the exemplary embodiment can also be combined in other ways, without deviating from the subject matter of the disclosure.

What is claimed is:

1. A driver assistance system for a motor vehicle, the driver assistance system comprising:
an environment camera including an image sensor and an optical system;
an imaging unit;
a display element in an interior of the motor vehicle;
wherein the environment camera, the imaging unit, and the display element form a digital exterior mirror, the digital exterior mirror arranged such that at least two visual field regions, a first visual field region and a second visual field region, are mapped with different magnifications.

2. The driver assistance system of claim 1, wherein the digital exterior mirror is arranged such that the at least the two visual field regions are mapped with different angular resolutions.

3. The driver assistance system of claim 1, wherein the environment camera detects electromagnetic radiation in a wavelength range between approximately 300 nm and approximately 2000 nm.

4. The driver assistance system of claim 1, wherein the environment camera comprises a wavelength band-pass filter with a passband of approximately 400 nm to approximately 750 nm.

5. The driver assistance system of claim 1, wherein the optical system implements the different magnifications.

6. The driver assistance system of claim 1, wherein:
the optical system includes a rotation-symmetric design; and
the optical system and the image sensor are aligned with one another such that an optical axis of the optical system passes near to an area centroid of a measurement surface of the image sensor.

7. The driver assistance system of claim 1, wherein the optical system has a non-rotation-symmetric design.

8. The driver assistance system of claim 1, wherein:
the image sensor comprises a sensor surface;
the optical system is configured such that the first visual field region is mapped similarly to a wide-angle lens on a first region of the sensor surface of the image sensor; and
the second visual field region of the digital exterior mirror is mapped similarly to a telephoto lens on a second region of the sensor surface.

9. The driver assistance system of claim 1, wherein the first visual field region covers an angle of greater than 50° and the second visual field region covers an angle of less than 30°.

10. The driver assistance system of claim 1, wherein each magnification used corresponds to an integer.

11. The driver assistance system of claim 10, wherein each magnification used corresponds to an even number, multiple of the basic scale.

12. The driver assistance system of claim 1, wherein the imaging unit is arranged such that image data of the environment camera are rescaled and undergo rectification, before being reproduced by the display element.
